(19) United States
(12) Patent Application Publication
(10) Pub. No.: US 2026/0352054 A1
(43) Pub. Date: Nov. 5, 2026

(54) METHOD FOR ELECTRICALLY CONTACTING A STRANDED WIRE WINDING TO A CARRIER PLATE AND A STRANDED WIRE WINDING

(71) Applicant: Maxon International AG, Sachseln (CH)

(72) Inventors: Robin DURRER, Luzern (CH); Bernd HAGE, Sarnen (CH); Remo SCHELLING, Lungern (CH); Mikhail PAVLOV, Sachseln (CH)

(21) Appl. No.: 19/118,532

(22) PCT Filed: Oct. 13, 2023
(86) PCT No.: PCT/EP2023/078542

§ 371 Date: Apr. 4, 2025

(30) Foreign Application Priority Data
Oct. 14, 2022 (EP) 22201623.0

(51) Int. Cl. H02K 3/50; H02K 3/38; H02K 15/104; H02K 15/33

(52) U.S. Cl. CPC H02K 3/50; H02K 3/38; H02K 15/104; H02K 15/33; H02K 2203/03

(57) ABSTRACT

The method includes the step of combining a stranded wire end and a sleeve so that the sleeve surrounds the stranded wire end over at least part of its length, at least in sections. The method proceeds with the step of electrically contacting the stranded wire end with the sleeve. The method continues with the step of inserting the stranded wire end fitted with the sleeve into the recess in a carrier plate. The winding is a stranded wire winding and the stranded wire ends have insulated individual wires and the insulation comprises a high-temperature-resistant coating. After inserting the stranded wire end fitted with the sleeve into the recess of the carrier plate, the stranded wire ends remain substantially aligned parallel to the axis of the winding, and the sleeve and the carrier plate are electrically contacted with one another.

### CROSS-REFERENCE TO REPLATED APPLICATIONS

The present application claims priority to PCT Patent App. No. PCT/EP2023/078542, filed on 13 Oct. 2023, and entitled “METHOD FOR ELECTRICALLY CONTACTING A STRANDED WIRE WINDING TO A CARRIER PLATE AND A STRANDED WIRE WINDING” and to European Patent App. No. 22201623.0, filed on 14 Oct. 2022, and entitled “METHOD FOR ELECTRICALLY CONTACTING A STRANDED WIRE WINDING TO A CARRIER PLATE AND A STRANDED WIRE WINDING,” the entire contents of both of these applications being herein incorporated by reference.

### BACKGROUND

### 1. Field

The present disclosure relates to a method for contacting a winding on a carrier plate and a stranded wire winding suitable for the method.

### 2. Related Art

In order to bundle the strands of a winding wire, it is known to hold the end of the winding wire open in a solder bath and thus tin it. However, depending on the type of insulating coating, there is a risk that it will not be completely melted away and that the strands will not be optimally bundled, which will make electrical contact even more difficult. In particular, insulating coating for sterilizable windings is very heat-resistant and therefore susceptible to faulty contact using a solder bath.

To ensure a good and secure connection to the carrier plate, the strands are thus inserted into sleeves and the sleeve is then electrically contacted with the carrier plate.

Since the installation space in the radial direction is very limited in the case of small electric motors, in particular in the case of small electric motors with a diameter of less than 100 mm and especially in the case of small electric motors with a diameter of less than 60 mm, the ends of the stranded wire together with the sleeve should advantageously maintain their axial alignment relative to the winding.

A method for contacting a winding with a carrier plate is known from DE102017206187. This document shows the contacting of a winding to a carrier plate by inserting the ends of the winding into crimp terminals attached to the carrier plate and crimping them thereto. The crimp connections together with the winding ends are then deformed into recesses so that the ends of the winding wires are no longer aligned in the axial direction of the winding, but are bent radially inwards or radially outwards and are positioned substantially parallel to the surface of the carrier plate.

However, such a method requires a lot of installation space in the radial direction and is not suitable for stranded wire windings, since bending the wire ends poses the risk of individual strands of the stranded wire breaking.

Another prior art document is US2011012468. It shows a radial gap motor with a hollow cylindrical winding. The winding is contacted with a carrier plate via its winding ends, which can consist of one or more wires, wherein the winding ends are inserted into through-holes in a carrier plate. However, crimping the winding ends is not described, nor is it explained how exactly the winding ends are contacted with the carrier plate.

Especially with small electric motors, there is only very limited space available for contacting the winding with the carrier plate. This makes the secure contacting of winding ends, which consist of a large number of individual wires, all the more complex.

### SUMMARY

The object of the present disclosure therefore is to provide a simple method for compact and secure contacting of a stranded wire winding with a carrier plate, and a stranded wire winding produced according to this method.

A solution to the problem exists if the winding is a stranded wire winding and the stranded wire ends have insulated individual wires and the insulation comprises a high-temperature-resistant coating, wherein after inserting the stranded wire end fitted with the sleeve into the recess of the carrier plate, the stranded wire ends remain substantially aligned parallel to the axis of the winding, and the sleeve and the carrier plate are electrically contacted with one another.

According to the present disclosure, the stranded wire ends are aligned substantially parallel to the axis of the stranded wire winding both before and after the sleeves are inserted into the recesses. Substantially parallel means that the deviation of the angle of alignment of the individual stranded wire ends to the axis of the stranded wire winding is a maximum of 15°, preferably a maximum of 10°and particularly preferably a maximum of 5°. This has the advantage that hardly any installation space is required in the radial direction and the stranded wire ends are not exposed to strong bending.

The winding is a stranded wire winding, which consists of individual wires over the entire length. The individual wires are each electrically insulated with coating over their entire length, thus the individual wires are insulated from one another. The stranded wire ends also have insulated individual wires, which are fitted with a sleeve. Stranded wires are more flexible than a wire with the same conductor cross-sectional area and, in addition, eddy currents can be avoided or reduced. The winding can be used to generate an electromagnetic field in a slotless or ironless motor.

Preferably, the stranded wire winding is hollow-cylindrical. However, the method according to the present disclosure can also be applied to stranded wire windings of other embodiments known to those skilled in the art.

According to an advantageous embodiment of the present method, the sleeve is designed as a closed sleeve and, in order to combine the sleeve and the stranded wire end, the sleeve is pushed over the stranded wire end in such a way that the stranded wire end is completely radially enclosed by the sleeve over at least part of its length. The sleeve can be pushed completely onto the stranded wire end so that the tip of the stranded wire end protrudes beyond the sleeve. However, it is also conceivable that the sleeve is only partially pushed onto the stranded wire end, so that the tip of the stranded wire end lies within the sleeve. Preferably, the sleeve is pushed onto the stranded wire end at least up to half its length, more preferably at least up to three quarters of its length. The sleeve may have a funnel shape on at least one side so that the strands of the stranded wire can be more easily inserted into the sleeve.

According to a further advantageous embodiment of the present method, the sleeve is designed as a sleeve blank when it is combined with the stranded wire end, which is re-shaped into the form of a sleeve and thus completely radially encloses the stranded wire end over at least part of the length range. The sleeve blank is preferably designed as a sheet metal strip, wherein the sheet metal strip has a width and a length, and wherein the length of the sheet metal strip is at least twice the width of the sheet metal strip and preferably the length is at least three times the width. The sheet metal strip is positioned along its length orthogonally to the orientation of the stranded wire end so that the sheet metal strip and the stranded wire end touch each other. The sheet metal strip is then bent inwards, towards the end of the stranded wire, so often until the sheet metal strip completely or almost completely encloses the end of the stranded wire. Advantageously, the sheet metal strip is bent three times in such a way that the stranded wire end is completely enclosed. It is also conceivable that the sheet metal strip is bent a fourth time so that two of the surfaces of the sheet metal strip created by the bending overlap. By subsequent electrical contact, a secure electrical connection is established between the bent metal strip and the stranded wire end. This can be done by soldering, crimping or other measures known to a person skilled in the art. The advantage over a closed sleeve and a slotted sleeve is that the sleeve blank does not have to be guided over the sensitive tips of the individual wires of the stranded wire end, thus significantly minimizing the risk of bending or breaking and, as a result, improper contact.

Preferably, the sleeve is open on both sides in the axial direction so that when the stranded wire end makes electrical contact with the sleeve, insulating coating can escape from the sleeve on both sides. This enables particularly good electrical contact between the stranded wire end and the sleeve. Both the closed sleeve and the sleeve blank, which is re-shaped into the form of a sleeve, are open on both sides in the axial direction and thus have two openings each in the axial direction. As a result, when the stranded wire end makes electrical contact with the sleeve, it is possible that insulating coating or, for example, tin and other substances which reduce the electrical conductivity of the contact escape from the sleeve on both sides. Because the materials escape from the sleeve on both sides, a bubble with insulating coating does not form on a closed side of the sleeve, for example, which would impair the electrical contact between the stranded wire end and the sleeve. In the connection process between the sleeve and the stranded wire end, the sleeve can be pressed together on one side, which only slightly affects the outflow of coating during the connection process between the stranded wire end and the sleeve, and does not lead to a bubble of insulating coating and deterioration of the contact between the stranded wire end and the sleeve. The sleeves can be wire end ferrules and have a funnel on at least one side in the axial direction, which facilitates the insertion of the stranded wires into the sleeve.

According to a particularly advantageous embodiment of the present method, the sleeve is contacted by crimping and preferably by hot crimping with the individual wires of the stranded wire end lying on the inner circumference. The individual wires of the stranded wire end are preferably electrically insulated by means of insulating coating. The crimping tool squeezes the sleeve in such a way that the copper of the individual wires is electrically connected to the crimped sleeve. The advantage of hot crimping is that by heating the area of the stranded wire end enclosed by the sleeve, the insulating coating of the individual wires of the stranded wire end is melted away. The heating takes place to at least 200 °C and preferably to at least 250 °C. At these temperatures, the insulating coating that surrounds the individual wires is melted away. Depending on the type of insulating coating, higher temperatures are required. Insulating coating, which is suitable for sterilizable parts, requires rather higher temperatures in order to melt away completely and thus enable good contact between the individual wires of the stranded wire end and the sleeve. For sterilizable parts, such as windings, high-temperature-resistant insulating coating (e.g. VT220) can be used. High-temperature-resistant insulating coatings are coatings which have a softening temperature according to IEC 60851-6 4 greater than 300 °C. These can preferably be polyamide-imide coatings, which are also suitable for sterilizable components. When using high-temperature-resistant or sterilizable coating for windings, the stranded wire ends should be heated to 500 °C to 900 °C, preferably 750 °C. At this temperature, the high-temperature-resistant coating reaches a low viscosity or partially evaporates. The pressure of the crimping tool presses the insulating coating out of the connection between the stranded wire and the crimp, creating a more or less pure metal connection. The metal connection has very good contact with high electrical and thermal conductivity. The sleeves or crimp sleeves can be made of tinned copper. The high temperature also causes the tin on the surface of the crimp to liquefy and be pressed out of the connection by the contact pressure of the crimping tool. This creates a particularly pure copper connection between the stranded wires and the sleeve, which conducts electrical current particularly well. The insulating coating pressed out of the crimp connection as well as the tin also partially pressed out of the crimp connection partially solidifies at the exit points of the crimp sleeve and thus forms a protective layer which protects the underlying contact between the stranded wire and the sleeve from corrosion.

Preferably, heating is achieved by applying an electric current with a current of 100 A to 200 A and preferably with a current of 140 A to 160 A. In addition to good electrical contact, one advantage of hot crimp connections is their robustness against vibrations.

By applying a high current to the sleeve, heat can be generated very locally in the crimp sleeve. This means that the immediate area around the sleeve is heated less, which is an advantage especially for small or short engines. The process is particularly suitable for contacting motors that are operated at high temperatures or for motors that are exposed to high temperatures, for example during a sterilization process.

According to a particularly preferred embodiment of the present method, the sleeve has a first width and a second width, wherein the first and second widths are aligned orthogonally to the longitudinal axis of the stranded wire end. The first and second widths may be aligned at right angles to each other. After electrical contact, the first width of the sleeve has a spatial extent that is twice as large as the second width. Preferably, the first width is four times wider than the second width. The sleeve therefore has a flattened shape after crimping.

According to a further preferred embodiment of the present method, for contacting, the stranded wire end with the sleeve is immersed in a tin bath until the insulation of the individual wires of the stranded wire end has melted. The time required to melt the insulation can be between 2 and 8 seconds, preferably 5 seconds. The time it takes to melt the insulation depends on the type of insulation used. In particular, insulating coating for sterilizable windings is very heat-resistant, which results in a longer melting time.

According to a particularly preferred embodiment of the present method, the recess of a first end face of the carrier plate has a depth that extends orthogonally from the first end face in the direction of a second end face, and the recess has a first width and a second width, wherein the first width and the second width are aligned at a right angle to one another, and wherein the sleeve is contacted with the stranded wire end in such a way that at least one width of the sleeve can be combined with at least one width of the recess of the first end face in such a way that there is a clearance of at least 0.1 mm, preferably of at least 1 mm, and more preferably of at least 2 mm. The difference between the first width of the sleeve and the first width of the recess is thus at least 0.1 mm, preferably at least 1 mm, and more preferably at least 2 mm. Furthermore, the difference between the second width of the sleeve and the second width of the recess is at least 0.1 mm, preferably at least 1 mm, and more preferably at least 2 mm.

Preferably, the sleeve and recess are matched to each other in such a way that the sleeve can be inserted into the recess without jamming and no more clearance is permitted than is necessary for the easiest possible assembly. The spacing also allows solder to flow from one end face through the recess to the opposite end face of the circuit board, thus enabling good electrical contact between the sleeve and the carrier plate.

The stranded wire winding and the carrier plate are aligned coaxially to each other to insert the sleeves into the recess. By rotation about the common axis, the stranded wire winding and the carrier plate are aligned with each other in such a way that the sleeve can be inserted into the recess by axially displacing the stranded wire winding and/or the circuit board.

Preferably, the profiles of the recess and/or the sleeve, which are defined by the respective first and second widths of the sleeve and the recess, taper so that assembly is further facilitated by this type of guide.

According to a particularly preferred embodiment of the present method, the recesses on the first end face of the carrier plate are designed to be open throughout to the second end face and to the lateral surface, wherein the carrier plate and the stranded wire winding are aligned with one another in such a way that the axis of the stranded wire winding and the longitudinal axis of the carrier plate, which runs orthogonally to the first end face of the carrier plate, run parallel to one another, and wherein the carrier plate and stranded wire winding are aligned with one another in the axial direction in such a way that the sleeve can be inserted into the recess by a movement radially inwards. Alternatively, it is conceivable that the stranded wire winding as a whole is moved in the direction of the recess to insert the sleeve. It is also conceivable that the carrier plate together with the recess is moved towards the sleeve or that the sleeve and recess are moved towards each other and the sleeve is thereby inserted into the recess.

According to a particularly preferred embodiment of the present method, the recesses are designed as slots which are open towards the lateral surface of the carrier plate, wherein the alignment of the longitudinal axis of the slots in the radial direction has an angle to the circle center of the end face, wherein this angle is 30°-60° and preferably 40°-50°, and wherein the sleeve is inserted into the slots of the carrier plate by radial displacement and the displacement is superimposed by an additional rotary movement of the carrier plate about the center of the end face. Advantageously, for this embodiment of the method according to the present disclosure, the sleeves are aligned according to the position of the slots. The widths of the sleeve and the recess are not only coordinated in terms of size, but also in their orientation. The first width of the sleeve can extend in the direction of the longitudinal axis of the slot.

After being inserted into the recess of the carrier plate, the sleeve is electrically contacted with the carrier plate. During electrical contact, a secure electrical contact is established between these two components by soldering, crimping or another measure known to those skilled in the art. According to a preferred embodiment of the present disclosure, the sleeve is electrically contacted with the carrier plate by soldering.

The present disclosure particularly preferably provides a stranded wire winding which is preferably produced according to one of the described embodiments of the claimed method.

According to a particularly preferred embodiment of the stranded wire winding according to the present disclosure, a stranded wire end comprises at least five individual wires and preferably at least fifteen individual wires. The stranded wire winding can also contain between 20 and 60 individual wires.

According to a further preferred embodiment of the stranded wire winding according to the present disclosure, the insulation of the individual wires of the stranded wire winding comprises a sterilizable coating. Sterilizable coating is characterized by its heat resistance, which is why hot crimping is preferably used to contact the stranded wire ends with the sleeve. Alternatively, the contact between the sleeve and the stranded wire end can also be achieved by means of a tin bath. The time during which the sleeve together with the stranded wire end is exposed to the tin bath must be extended accordingly compared to the use of a non-sterilizable coating. Alternatively or additionally, the tin bath can be heated to a higher temperature. For example, the temperature of the tin bath can be more than 300 °C and up to 400 °C

According to a further preferred embodiment of the stranded wire winding according to the present disclosure, the stranded wire ends are arranged over a circumferential section of at most 180° and preferably over a circumferential section of at most 150° of the stranded wire winding. The recesses of the first end face of the carrier plate are correspondingly also distributed over a circumferential section of at most 180° and preferably over no more than 150° and are arranged in such a way that, when the stranded wire winding and the carrier plate are coaxially aligned, they can be positioned by rotating the stranded wire winding or the carrier plate in such a way that the stranded wire ends can be guided into the recesses by a movement in the axial direction of the stranded wire winding or the carrier plate.

### BRIEF DESCRIPTION OF THE DRAWINGS

The method according to the present disclosure is explained below with reference to the figures.

They show:

FIG. 1: a schematic representation of a stranded wire winding according to the present disclosure and a carrier plate;

FIG. 2: a schematic representation of the stranded wire end according to FIG. 1;

FIG. 3a: a schematic representation of a stranded wire end with a closed sleeve;

FIG. 3b: a schematic representation of a stranded wire end with a closed sleeve;

FIG. 4: a schematic representation of the positioning of a sleeve blank to the stranded wire end;

FIG. 5: a schematic representation of the alignment of the stranded wire ends;

FIG. 6: a schematic representation of alternative embodiments of the carrier plate; and

FIG. 7: a schematic representation of the stranded wire winding and the carrier plate after carrying out the method according to the present disclosure.

### DETAILED DESCRIPTION OF THE ENABLING EMBODIMENTS

In the following embodiments, like parts are denoted by like reference signs. If a figure contains reference signs that are not discussed in detail in the corresponding figure description, reference is made to preceding or subsequent figure descriptions.

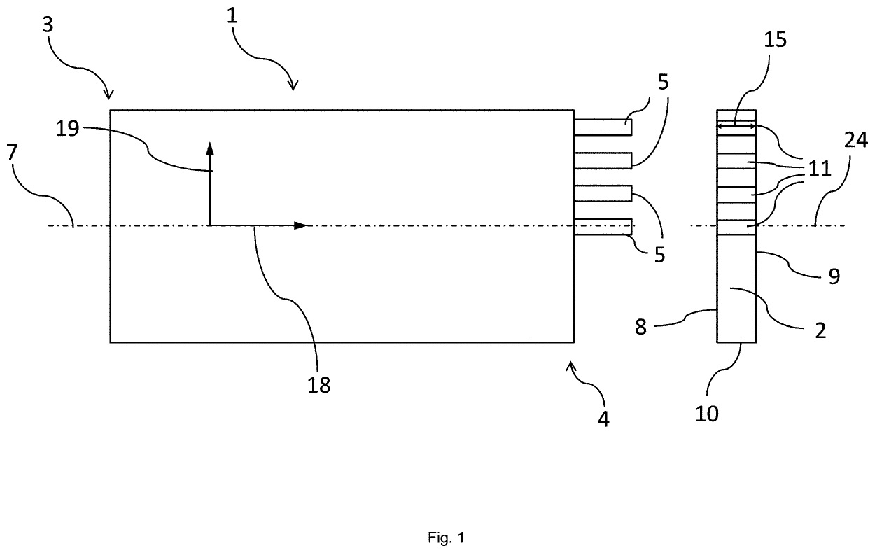

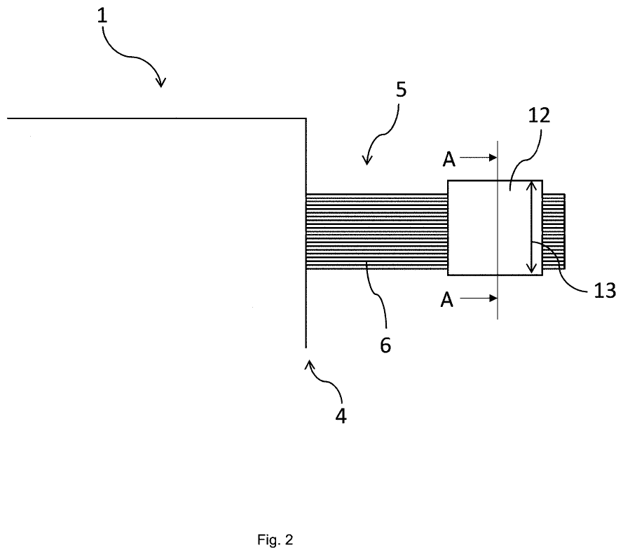

FIG. 1 shows schematically a first embodiment of a stranded wire winding 1 having four stranded wire ends 5. The stranded wire winding 1 has a hollow-cylindrical shape with a first axial end 3, a second axial end 4 opposite the first axial end 3, and an axis 7. With respect to the stranded wire winding 1, an axial direction 18 and a radial direction 19 are defined. The stranded wire ends 5 comprise, as shown in FIG. 2, a plurality of individual wires 6, are aligned parallel to the axis 7 of the stranded wire winding 1 and protrude beyond the second axial end 4. In addition, the stranded wire ends 5 are distributed over a partial circumference of the stranded wire winding 1, in this first embodiment approximately over a quarter of the circumference of the stranded wire winding 1. FIG. 1 further shows a carrier plate 2 with a first end face 8 facing the stranded wire winding 1, a second end face 9 and a lateral surface 10. The carrier plate 2 is circular and has a longitudinal axis 24. The four recesses 11 of the first end face 8 have a depth 15 and extend continuously up to the second end face 9. The stranded wire winding 1 and the carrier plate 2 are aligned coaxially with each other and, as can be clearly seen in FIG. 1, the stranded wire ends 5 and the recesses 11 are also axially aligned with each other.

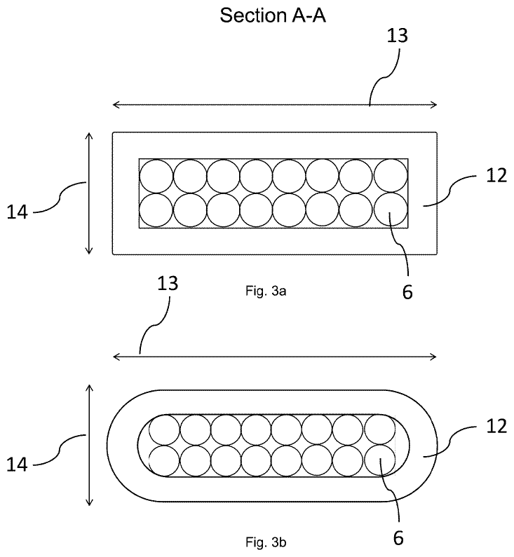

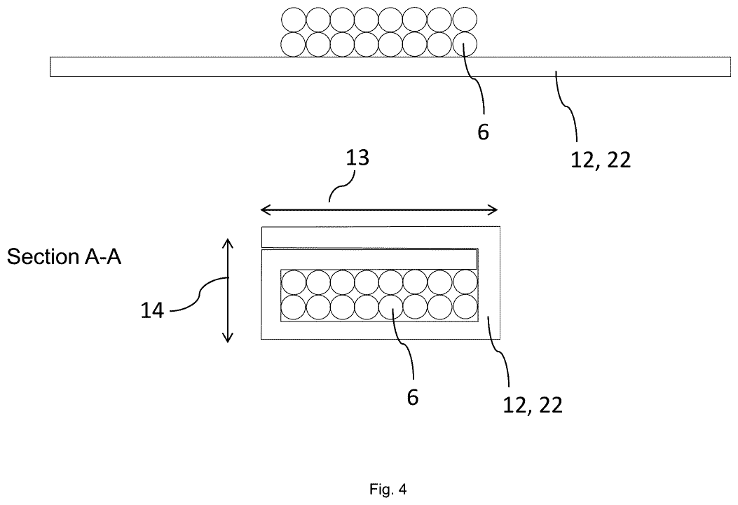

As shown in FIG. 2, a stranded wire end 5 comprises a plurality of individual wires 6. Preferably, a stranded wire end 5 comprises at least fifteen individual wires 6. The stranded wire end 5 is contacted with a sleeve 12, wherein the sleeve 12 completely surrounds a part of the stranded wire end 5. The sleeve 12, which has a first width 13, can be designed as a closed sleeve 12, see FIG. 3, wherein the sleeve 12 is then pushed onto the stranded wire end 5. Alternatively, the sleeve 12 can be designed as a sleeve blank 22 before contacting, see FIG. 4. In the exemplary embodiment shown, the stranded wire end 5 protrudes beyond the sleeve 12. However, it is also conceivable that the connection between the stranded wire end 5 and the sleeve 12 is designed in such a way that the tips of the stranded wire end 5 end within the sleeve 12.

The sleeve 12 is open on both sides in the axial direction so that when the stranded wire end 5 makes electrical contact with the sleeve 12, insulating coating can escape from the sleeve on both sides. This enables a particularly good electrical contact between the stranded wire end 5 and the sleeve 12. Both the closed sleeve 12 and the sleeve blank 22, which is re-shaped into the form of a sleeve 12, are open on both sides in the axial direction and thus have two openings each in the axial direction. As a result, when the stranded wire end 5 makes electrical contact with the sleeve 12, it is possible that insulating coating or, for example, tin and other substances, which reduce the electrical conductivity of the contact, escape from the sleeve 12 on both sides in the axial direction along the stranded wire end 5. Because the materials escape from the sleeve 12 on both sides, a bubble with insulating coating, which would impair the electrical contact between the stranded wire end 5 and the sleeve 12, does not form on a closed side of the sleeve 12, for example. In the connection process between the sleeve 12 and the stranded wire end 5, the sleeve 12 can be pressed together on one side, which only slightly affects the outflow of coating during the connection process between the stranded wire end 5 and the sleeve 12, and does not lead to a bubble of insulating coating and deterioration of the contact between the stranded wire end 5 and the sleeve 12. The sleeve 12 can be a wire end ferrule and have a funnel on at least one side in the axial direction, which facilitates the insertion of the stranded wire ends 5 into the sleeve 12. Sleeve 12 can also have a funnel on both sides. The funnel shape of the sleeve is not shown in FIG. 2.

FIGS. 3a and 3b show the section A-A from FIG. 2 through the sleeve 12. The sleeve 12 is designed here as a closed sleeve and surrounds several individual wires 6. The sleeve 12 and the stranded wire end 5 are in contact with each other and the sleeve 12 has a first width 13 and a second width 14 which are aligned orthogonally to the axis 7 of the hollow cylindrical winding and at a right angle to each other, the first width 13 corresponding approximately to three times the length of the second width 14. It is easy to see that the sleeve has a flattened shape. In FIG. 3a, the outer edges of the first width 13 and the second width 14 are straight. The outer edges can be at a right angle to each other, as shown in FIG. 3a. In particular, the outer edges of the second width can also run in a semi-circle, as shown in FIG. 3b.

FIG. 4 shows in the lower illustration the section A-A in an alternative embodiment. The sleeve 12 is designed here as a sleeve blank 22 before contacting. As the upper illustration of FIG. 4 shows, the sleeve blank 22 can be designed, for example, as a sheet metal strip. The sheet metal strip is aligned orthogonally to the stranded wire end 5 along its length and is brought to the stranded wire end 5 in such a way that the stranded wire end 5 and the sheet metal strip touch. The sheet metal strip is then bent inwards, towards the end 5 of the stranded wire, so often until the sheet metal strip completely or almost completely encloses the end 5 of the stranded wire. A possible result of this bending process is shown in the lower image of FIG. 4. The sheet metal strip is bent four times so that two of the surfaces of the sheet metal strip created by the bending overlap. It is also conceivable to bend the sheet four times, wherein the two overlapping surfaces only partially overlap. Alternatively, bending three times may be sufficient, in which case there is no need for overlapping. By subsequent contact, a secure electrical connection is established between the bent metal strip and the stranded wire end 5. The advantage over a closed sleeve 12 and a slotted sleeve is that the sleeve blank 22 does not have to be guided over the sensitive tips of the individual wires 6 of the stranded wire end 5 and thus the risk of breakage and, as a result, improper contact is considerably minimized. The contact between the sleeve 12 and the stranded wire end 5 is preferably made by crimping. Alternatively, the sleeve 12 together with the stranded wire end 5 can be dipped into a tin bath for contacting.

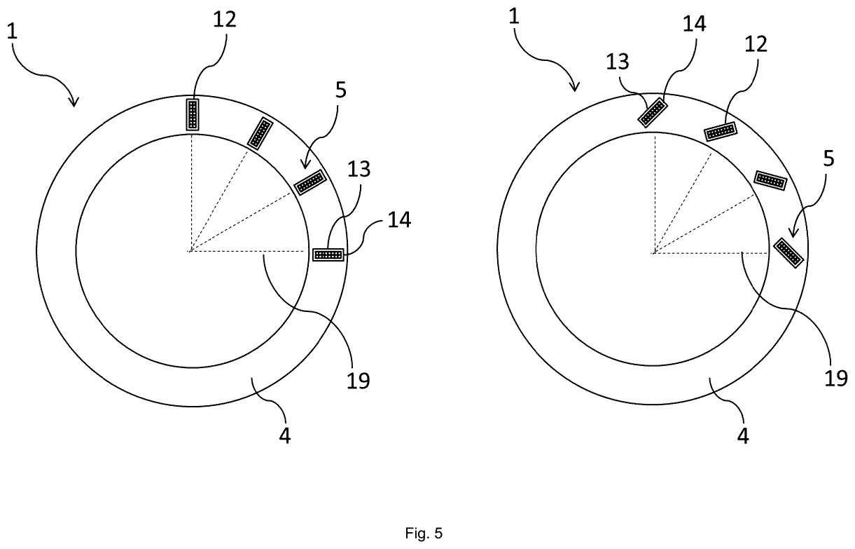

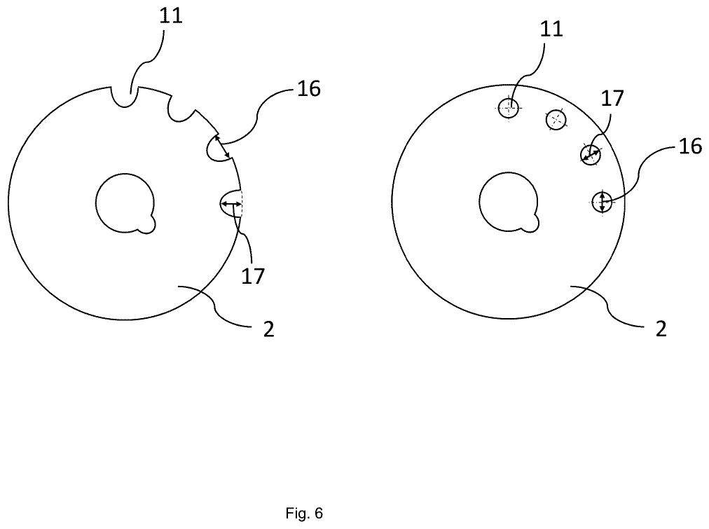

FIG. 5 shows two alternative embodiments of the stranded wire winding 1 according to the present disclosure. It can be clearly seen that the stranded wire ends 5 are distributed over approximately a quarter of the circumference of the stranded wire winding 1. As the two images in FIG. 5 show, the orientation of the stranded wire ends 5 can vary. The orientation is substantially defined by the orientation of the first and second widths 13, 14 of the sleeve 12 relative to the respective radial direction 19 of the stranded wire winding 1. The orientation and arrangement of the stranded wire ends 5 and the sleeve 12 are preferably coordinated with the arrangement and orientation of the recesses 11 of the carrier plate 2, see FIG. 6.

FIG. 6 shows two preferred embodiments of the carrier plate 2 for the method according to the present disclosure. The right image of FIG. 6 shows recesses 11 which are designed as through-holes. In a particularly preferred embodiment of the carrier plate 2, the recesses 11 are open towards the lateral surface 10, as shown in the left illustration of FIG. 6. Preferably, the edges of the recesses 11 are rounded towards the lateral surface 10 in order to facilitate the insertion of the sleeves 12 into the recesses 11 during assembly. Regardless of the design of the recesses 11, the recesses 11 have a first width 16 and a second width 17.

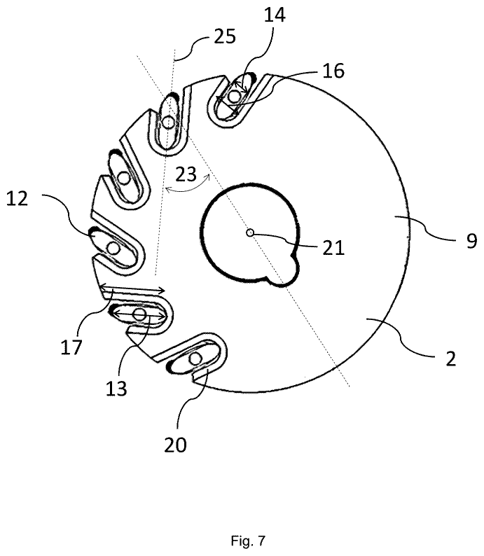

FIG. 7 shows the carrier plate 2 after the sleeve 12 has been inserted into the recesses 11. Particularly preferably, the recesses 11 are designed as slots 20 which are open towards the lateral surface 10 of the carrier plate 2, wherein the alignment of the longitudinal axis 25 of the slots 20 in the radial direction to the circle center 21 of the second end face 9 has an angle 23, wherein this angle is 30°-60° and preferably 40°-50°. Advantageously, for the method according to the present disclosure, the sleeves 12 are aligned according to the position of the slots 20. The second width 14 of the sleeves 12 and the first width 16 of the recesses 11 are not only coordinated in terms of size, but also in their orientation. The first width 13 of the sleeve 12 extends in the direction of the longitudinal axis 25 of the slot 20, wherein the first width 13 of the sleeve 12 and the second width 17 of the slot 20 are coordinated with one another in such a way that the sleeve 12 can be inserted almost completely into the slot.

According to a particularly advantageous embodiment of the method according to the present disclosure, the sleeves 12 and the slots 20 are positioned at the same height and adjacent to one another in the axial direction 18 of the stranded wire winding, and the stranded wire winding 1 and the carrier plate 2 are aligned coaxially with one another. The stranded wire ends 5 are bent slightly radially outwards. Advantageously, the stranded wire ends 5 are sufficiently long so that a slight bending of the stranded wire ends 5 does not lead to a breakage of individual wires 6 or even to a breakage of the stranded wire end 5. The sleeves 12 are then moved radially inwards and thereby inserted into the slots 20. Preferably, a rotational movement of the carrier plate 2 relative to the stranded wire winding 1 takes place at the same time. This has the advantage that the insertion of the sleeves 12 into the slots 20 is simplified during assembly. It is advantageous if the side surfaces of the sleeves 12 are rounded.

According to a further preferred embodiment of the present method, the sleeve 12 is soldered to the carrier plate 2 after being inserted into the recess 11 of the carrier plate 2 for contacting. Soldering offers the advantage of extremely robust electrical contact and makes additional clamping mechanisms unnecessary.

What is claimed is:

1. A method for contacting a winding with a carrier plate, wherein the winding has a first axial end and an opposite second axial end, and wherein the winding comprises at least two stranded wire ends for electrical connection to the carrier plate, and wherein the stranded wire ends protrude beyond an axial end of the winding, are aligned substantially parallel to the axis of the winding and are distributed over at least a partial circumference of the winding, and wherein the carrier plate has a first end face facing the stranded wire ends and a second end face facing away from the stranded wire ends as well as a lateral surface, and wherein the first end face has recesses for receiving the stranded wire ends, comprising the following method steps:
combining the stranded wire end and a sleeve, so that the sleeve surrounds the stranded wire end over at least part of its length, at least in sections,
electrically contacting the stranded wire end with the sleeve,
inserting the stranded wire end fitted with the sleeve into the recess in the carrier plate, wherein the winding is a stranded wire winding and the stranded wire ends have insulated individual wires and the insulation comprises a high-temperature-resistant coating, wherein after inserting the stranded wire end fitted with the sleeve into the recess of the carrier plate, the stranded wire ends remain substantially aligned parallel to the axis of the winding and the sleeve and the carrier plate are electrically contacted with one another.

2. The method according to claim 1, wherein the sleeve is designed as a closed sleeve and, in order to combine the sleeve and the stranded wire end, the sleeve is pushed over the stranded wire end and the stranded wire end is completely radially enclosed over at least part of its length.

3. The method according to claim 1, wherein the sleeve is designed as a sleeve blank when combined with the stranded wire end, which is re-shaped into the form of a sleeve and thus completely radially encloses the stranded wire end over at least part of its length.

4. The method according to claim 1, wherein the sleeve is open on both sides in the axial direction, so that when the stranded wire end is electrically contacted with the sleeve, insulating coating can escape on both sides.

5. The method according to claim 1, wherein the sleeve is contacted by crimping with the individual wires of the stranded wire end lying on the inner circumference.

6. The method according to claim 16, wherein for hot crimping the area of the stranded wire end enclosed by the sleeve is heated to 500 °C to 900 °C whereby the insulating coating of the individual wires of the stranded wire end is melted away.

7. The method according to claim 1, wherein the sleeve has a first width and a second width, wherein the first and the second width are aligned orthogonally to the longitudinal axis of the stranded wire end, and wherein, after contacting the sleeve with the stranded wire end, the first width of the sleeve has a spatial extent that is at least twice as large and preferably at least four times as large as the second width of the sleeve.

8. The method according to claim 1, wherein, for contacting, the stranded wire end and the sleeve are immersed in a tin bath until the insulation of the stranded wire end has melted.

9. The method according to claim 1, wherein the recess of the first end face of the carrier plate has a depth which extends orthogonally from the first end face in the direction of the second end face, and wherein the recess has a first width and a second width, wherein the first width and the second width are aligned at a right angle to one another, and wherein the sleeve is contacted with the carrier plate in such a way that at least one width of the sleeve can be combined with at least one width of the recess of the first end face in such a way that there is a clearance of at least 0.1 mm, preferably of at least 1 mm, and more preferably of at least 2 mm.

10. The method according to claim 1, wherein the recesses on the first end face of the carrier plate are designed to be open throughout to the second end face and to the lateral surface, wherein the carrier plate and the stranded wire winding are aligned with one another in such a way that the axis of the stranded wire winding and the longitudinal axis of the carrier plate, which runs orthogonally to the first end face of the carrier plate, run parallel to one another, and wherein the carrier plate and stranded wire winding are aligned with one another in the axial direction in such a way that the sleeve is introduced into the recess by radially displacing the carrier plate or by radially displacing the stranded wire winding or by radially displacing the sleeve.

11. The method according to claim 10, wherein the recess is designed as a slot which is open towards the lateral surface of the carrier plate, wherein the alignment of the longitudinal axis of the slot in the radial direction has an angle to the circle center of the end face wherein this angle is 30°-60°, and wherein the sleeve is inserted into the slot of the carrier plate by radial displacement and the displacement is superimposed by an additional rotary movement about the axis of the stranded wire winding or about the center of the circular end face.

12. The method according to claim 1, wherein following the insertion of the sleeve into the recess of the carrier plate, the sleeve is soldered to the carrier plate for contacting.

13. A stranded wire winding produced by a method according to claim 1.

14. The stranded wire winding according to claim 13, wherein a stranded wire end comprises at least five individual wires.

15. The stranded wire winding according to claim 13, wherein the stranded wire ends are arranged over a circumferential section of at most 180°.

16. The method according to claim 5, wherein the crimping is hot crimping.

17. The method according to claim 9, wherein the clearance between the sleeve and the recess is at least 2 mm.

18. The method according to claim 11, wherein the angle of the alignment of the longitudinal axis to the circle center of the end face is 40°-50°.

19. The stranded wire according to claim 14, wherein the standard wire end comprises at least fifteen individual wires.

20. The stranded wire winding according to claim 15, wherein the stranded wire ends are arranged over a circumferential section of at most 150° of the stranded wire winding.
